(19) United States
(12) Patent Application Publication
(10) Pub. No.: US 2013/0006697 A1
(43) Pub. Date: Jan. 3, 2013

(54) USING PRIME NUMBERS AND PRIME NUMBER FACTORIZATION TO TRACK ARTICLES THROUGH TRANSIT POINTS IN A SUPPLY CHAIN

(75) Inventors: Vivek BHASKAR, Bihar (IN); Nitin CHATURVEDI, Pune (IN); Varun K. MISHRA, Pune (IN)

(73) Assignee: INTERNATIONAL BUSINESS MACHINES CORPORATION, Armonk, NY (US)

(21) Appl. No.: 13/172,781

(22) Filed: Jun. 29, 2011

(51) Int. Cl. G06Q 10/00

(52) U.S. Cl. 705/7.27

(57) ABSTRACT

Provided are a computer program product, system and method for using prime numbers and prime number factorization to track articles through transit points in a supply chain. A list associates prime numbers with transit points through which the article passes. A determination is made from the list of prime numbers associated with the transit points through which the article has passed. A function is performed on the determined prime numbers to determine a composite value. An association is generated of the composite value with the article. The composite value associated with the article is used to determine at least one of the transit points through which the article has passed.

### BACKGROUND OF THE INVENTION

1. Field of the Invention

The present invention relates to a computer program product, system, and method for using prime numbers and prime number factorization to track articles through transit points in a supply chain.

2. Description of the Related Art

Manufacturers and producers need to trace the flow of their products through the production and distribution supply chain. Traceability refers to the capability for tracing goods along the distribution chain on a batch number or series number basis. Traceability is an important aspect in many industries, such as the automotive industry and food industries, where it is important to determine a transit point at which the goods have passed so that a determination may be made whether a problem, error or contamination is introduced due to a process at a particular transit point in the system.

Current traceability systems often involve the use of complex enterprise level databases to track products and containers, and the use of Radio-frequency identification (RFID) devices and barcodes to track products as they move through the supply chain. Information in RFID tags located on a container including the product may be updated with tracking information as the product flows through the supply chain.

For instance, traceability can be critical for a dairy producer, especially if a milk packet is contaminated. The dairy producer must immediately determine the source of the contamination so that other packets similarly affected can be recalled and the problem at the source can be located and corrected. Traceability is also important to detect and locate problems resulting from third party activities, such as contamination introduced by a third party tanker operator.

Current traceability systems can be expensive and require substantial investment in traceability software and RFID tags and devices. There is a need in the art for alternative low cost traceability techniques to track and trace products as they move through the supply chain.

### SUMMARY

Provided are a computer program product, system and method for using prime numbers and prime number factorization to track articles through transit points in a supply chain. A list associates prime numbers with transit points through which the article passes. A determination is made from the list of prime numbers associated with the transit points through which the article has passed. A function is performed on the determined prime numbers to determine a composite value. An association is generated of the composite value with the article. The composite value associated with the article is used to determine at least one of the transit points through which the article has passed.

### BRIEF DESCRIPTION OF THE DRAWINGS

FIG. 1 illustrates an embodiment of a computing environment.

FIG. 2 illustrates an embodiment of a transit point list entry in a transit point list of transit points through which a product passes.

FIG. 3 illustrates an embodiment of an article entry in article tracking information.

FIG. 4 illustrates an additional embodiment of a computing environment.

FIG. 5 illustrates an embodiment of operations to process an article passing through a transit point in the supply chain.

FIG. 6 illustrates an embodiment of operations to determine at least one transit point through which an article has passed.

FIG. 7 illustrates an embodiment of operations to determine whether an article has passed through a selected at least one transit point.

FIG. 8 illustrates an embodiment of the computers in the computing environments of FIGS. 1 and 4.

### DETAILED DESCRIPTION

Described embodiments concern techniques for tracking the transit points at which an article passes during its production and/or distribution in a supply chain. An article comprises any good to be tracked as it is processed at different production and/or distribution transit points in the supply chain. For instance, the article may comprise a drug, medicine, biological material, manufactured food stuff, commodity (e.g., food, animal livestock, meat, poultry, base and precious minerals, etc.), product, electronic goods, appliances, etc. Further, the article as it passes through the transit points may be maintained in a packaging or an identifiable container.

At production transit points in the supply chain, the article may be further transformed, modified, enhanced, tested, etc., as part of a manufacturing/production process to produce the final article. At distribution transit points, the article may be processed for further distribution to a next transit point or the final point of destination, such as the consumer, retailer, etc.

In a further embodiment, the article may comprise computer code, a broadcast, or digital media being transmitted over a wired or wireless network, and the transit points may comprise servers and switches in the network at which the software article is processed while transiting through the computer or broadcast network.

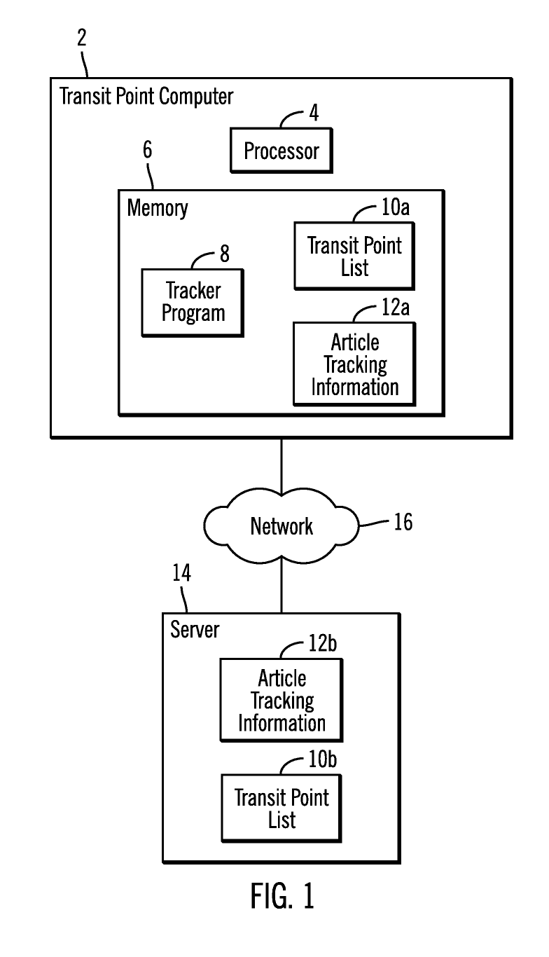

FIG. 1 illustrates an embodiment of a transit point computer 2 that is located at different transit points in the production and distribution supply chain at which the article is processed. The transit point computer 2 includes a processor 4, such as one or more microprocessors, central processing units (CPUs), etc., and a memory 6 including a tracker program 8 to perform tracking operations with respect to articles being tracked, a transit point list 10a providing an association of different transmit points with different prime numbers, and article tracking information 12a providing an association of articles and composite values. A composite value is the result of a function performed with respect to the prime numbers associated with the transit points through which the article has passed. For instance, in one embodiment, the composite value for an article identified in the article tracking information 10 may comprise a result of multiplying the prime numbers assigned to the transit points through which the article has passed.

The transit point computers 2 at each transit point may communicate with a server 14 over a network 16. The server 14 may maintain a centralized and most current version of the transit point list 10b and the article tracking information 12b, such that each of the transit point computers 2 at the different transit points may access the most current version of the transit point list 10b and article tracking information 12b from the server 14 to use locally as tracking point list 10a and article tracking information 12b at the transit point computer 2.

The memory 6 may comprise a volatile or non-volatile memory device in which programs and data are maintained for execution. In one embodiment, the network 16 may comprise a local area network (LAN), storage area network (SAN), wide area network (WAN), the Internet, an Intranet, a wireless network, etc.

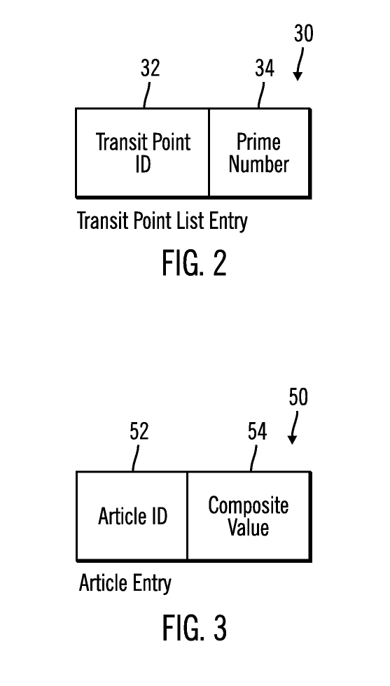

FIG. 2 illustrates an embodiment of a transit point entry 30 in the transit point list 10a, 10b, including a transit point identifier (ID) 32 providing a unique identifier of one of the transit points through which articles pass and a prime number 34 assigned to that transit point 32. In one embodiment, a unique prime number may be assigned to each transit point or, alternatively, one prime number may be associated with multiple transit points.

FIG. 3 illustrates and embodiment of an article entry 50 in the article tracking information 12a, 12b including an article identifier (ID) 52 and a composite value 54 for the article 52 calculated based on a function applied to the prime numbers of the transit points through which the article has passed, such as a result of multiplying all the prime numbers for the transit points.

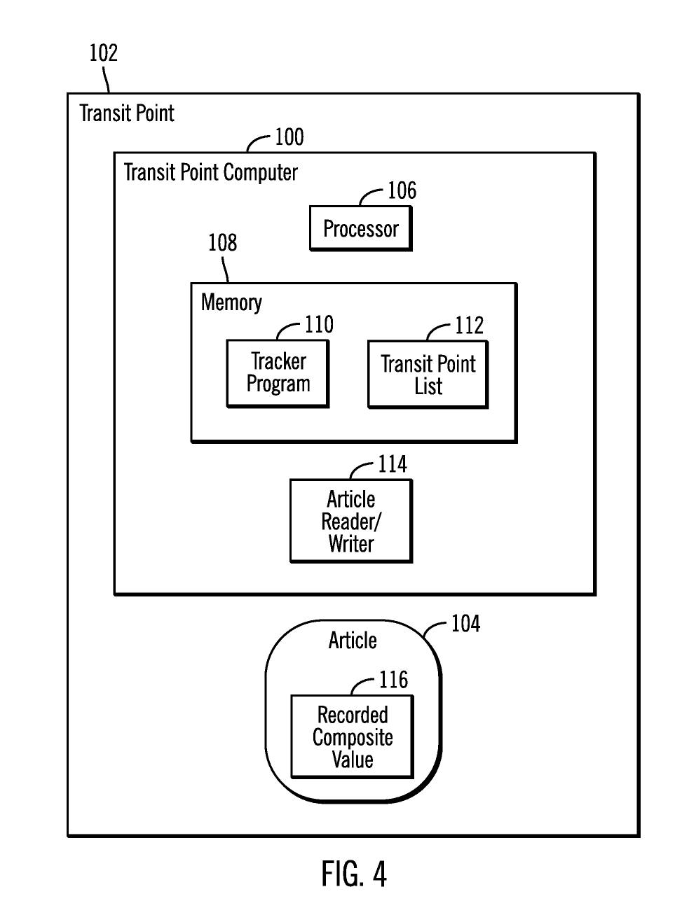

FIG. 4 illustrates an additional embodiment of a transit point computer 100 that may be deployed at the transit points 102 in the production and distribution supply chain at which an article 104 is processed. The computer 100 includes a processor 106 and a memory 108 having programs executed by the processor 106, including a tracker program 110 to perform article tracking operations for articles 104 passing through the transit point 102 and a transit point list 112, such as the transit point lists 10a, 10b discussed with respect to FIGS. 1 and 2. The computer 100 further includes an article reader/writer 110 having the capability to read a composite value recorded on the article or a packaging of the article and write an updated composite value to an article 112 being processed at the transit point 102. The article packaging may include multiple instance of the article and may comprise a box package, plastic package, bottle, container, etc. The computer 100 further includes an article reader/writer 114 capable of reading and writing with respect to the recorded composite value 116 on the article 104 or on a packaging including the article. The computer 100 may interface with a server 14 (FIG. 1) over a network 16 to obtain an updated transit point list 10a and may include article tracking information 12a as described with respect to FIG. 1.

In an embodiment where the recorded composite value 116 comprises an RFID tag on which the composite value is encoded, the article reader/writer 114 may comprise an RFID transmitter to read and write to the RFID tag including the recorded composite value 116. In an embodiment where the recorded composite value 116 comprises a bar code printed on the article 104 or a packaging of the article 104, then the article reader/writer 114 may comprise a bar code reader and printer capable to print an updated composite value 116 bar code on the article 104 or the packaging of the article. The article reader/writer 114 may be comprised of other technology capable of reading a composite value printed, encoded in, or superimposed upon the article or packaging of the article and capable of writing or printing an updated composite value for the recorded composite value 116. For instance, in one embodiment, the article reader/writer 114 may print a label or tag having an encoding of the updated composite value (e.g., a bar code, number or other encoding) that may then be placed on the article 104 or packaging of the article to form the new recorded composite value 116. The article reader/writer 114 may further have the capability to print the new composite value directly on the article 104 or its packaging or mechanically place a printed label or tag having the updated composite value on the article or packaging of the article to replace the previous recorded composite value 116. In an alternative embodiment, the article reader/writer 114 may cause the printing or output of the label or tag so that a person or other machine may apply the label or tag to the article 104 or article packaging. Alternatively, the article reader/writer 114 may output the updated composite value via a printout or display, and a person or machine may then manually write the new composite value on the article 104 or article packaging.

The computers 2, 14, and 100 may comprise any suitable computer system known in the art, such as a desktop computer, laptop, server, mainframe, hand held computing device, telephony device, computer networks, etc

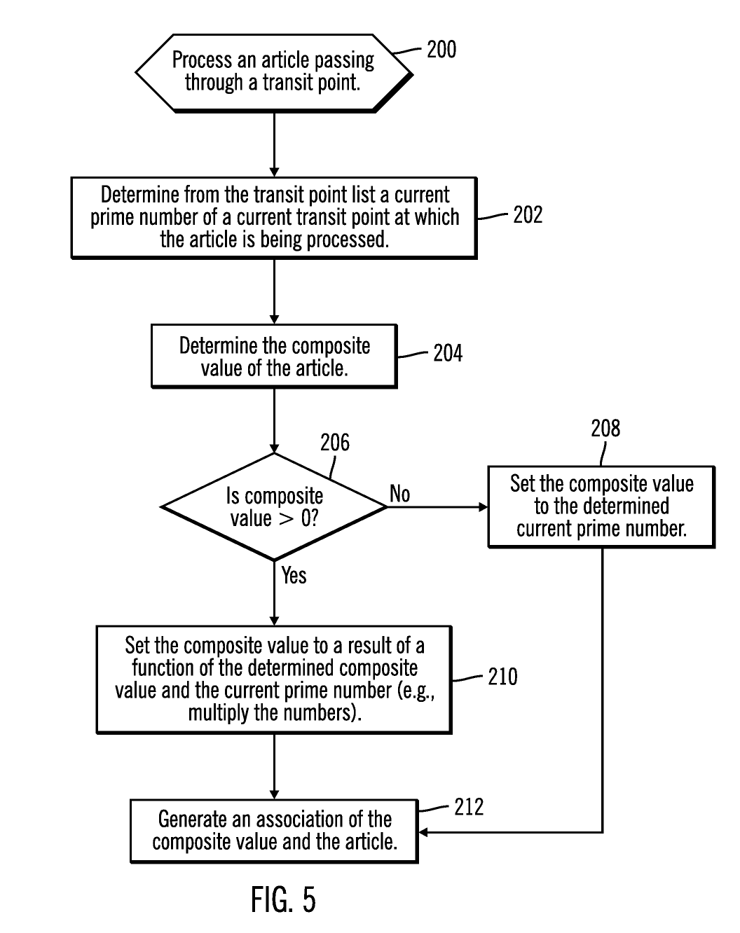

FIG. 5 illustrates an embodiment of operations performed by the tracker program 8, 110 to perform article tracking operations. Upon processing (at block 200) the article at a transit point, the tracker program 8, 110 determines (at block 202) from the transit point list 10a, 112 a current prime number 34 of a current transit point 32 at which the article is currently being processed. The composite value of the article is determined (at block 204). The composite value may be determined by user entry at an input device of the computer 2, 102 or be read from the article 104 using an article reader/writer 114. If (at block 206) the composite value is not greater than zero, i.e., is at the first transit point in the production/distribution chain, then the tracker program 8, 110 sets (at block 208) the composite value to the determined current prime number. If (at block 206) the composite value is greater than zero, then the tracker program 8, 110 sets (at block 210) the composite value to a result of a function of the determined composite value and the current prime number. In one embodiment, the function may comprise multiplying the determined composite value times the prime number of the transit point 102 at which the article is currently located. From block 208 or 210, control proceeds to block 212 where the tracker program 8, 110 generates an association of the updated composite value with the article. In one embodiment, the association may be made by updating the article entry 50 for the article with the new composite value 54 (FIG. 3) to include in the article tracking information 12a, 12b. Generating the association may further involve updating the recorded composite value 116 on the article 114 manually or with the article reader/writer 114.

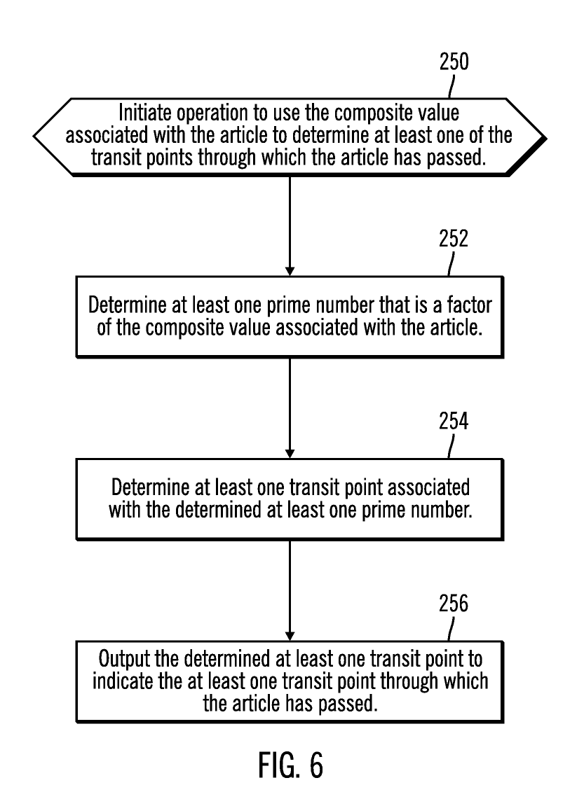

FIG. 6 illustrates an embodiment of operations performed by the tracker program 8, 110 to use the composite value of an article to determine information on the transit points through which the article has passed. Upon initiating (at block 250) an operation to use the composite value of an article to determine transit points, the tracker program 8, 110 determines (at block 252) at least one prime number that is a factor of the composite value associated with the article. Each prime number factor would identify a transit point through which the article has passed. In one embodiment, the tracker program 8, 110 may determine all prime factors of the composite value. The tracker program 8, 110 may perform a prime factorization of the composite value to obtain a list of the prime factors of the composite value. The tracker program 8, 110 may use the fundamental theorem of arithmetic which states that every positive integer has a unique prime factorization. For certain very large composite values, such as having more than 200 numerals, it may not be possible to determine the prime factors of the composite value. In such case, an error may be produced or the system may be designed so that composite values that are not capable of being subject to prime factorization are not produced.

After determining the prime factors of the composite value, the tracker program 8, 110 determines (at block 254) from the transit point list 10a, 112 at least one transit point 32 associated with the determined at least one prime number 34 (FIG. 2) and then outputs (at block 256) the determined at least one transit point to indicate the at least one transit point through which the article has passed. The output may be in the form of a display on a computer monitor, a print out on paper, a transmission in a web page to a remote computer, a transmission to another computer in an email or message, etc.

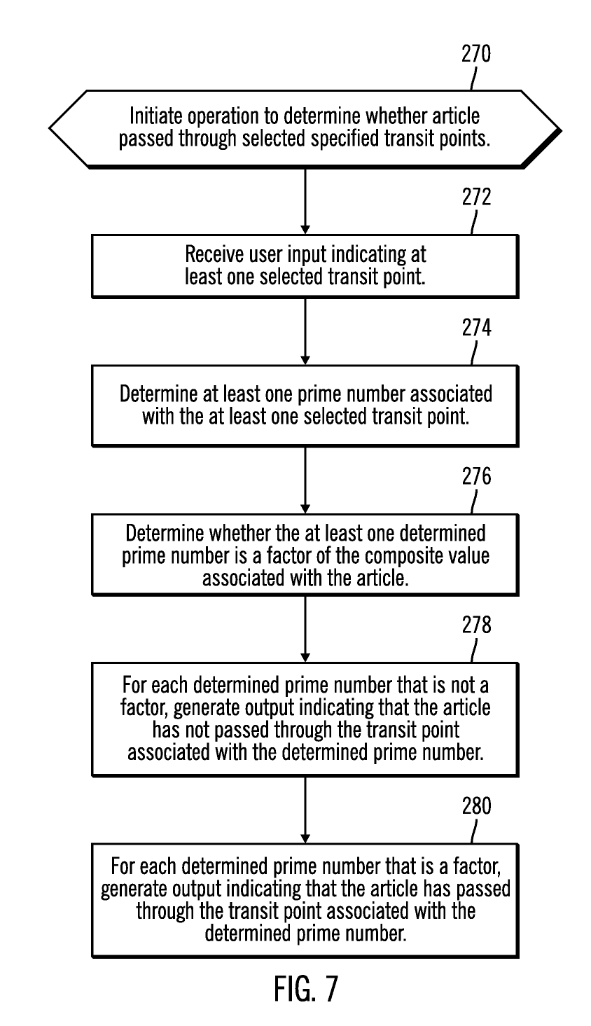

FIG. 7 illustrates an embodiment of operations performed by the tracker program 8, 110 to determine whether an article has passed through a user selected transit point. Upon initiating (at block 270) this determination, the tracker program 8, 110 receives (at block 272) user input indicating at least one selected transit point. The input may be received via a user interface rendered at the transit computer 2, 100 or alternatively may be received from remote system over the network 16. The tracker program 8, 110 determines (at block 274) at least one prime number associated with the at least one selected transit point from the transit point list 10a, 112. The tracker program 8, 110 then determines (at block 276) whether the at least one determined prime number is a factor of the composite value associated with the article. For each determined prime number that is not a factor, output is generated (at block 278) indicating that the article has not passed through the transit point associated with the determined prime number that is not a factor. For each determined prime number that is a factor, output is generated (at block 280) indicating that the article has passed through the transit point associated with the determined prime number that is a factor. The output may be in the form of a display on a computer monitor, a print out on paper, a transmission in a web page to a remote computer, a transmission to another computer in an email or message, etc.

Described embodiments provide techniques that may be relatively low cost to implement to track the movement of articles through transit points using prime numbers and the factorization principle to determine transit points through which an article has passed. This provides a tracking technique that does not require substantial communication and coordination, and investment in enterprise software and RFID devices, but instead the use of tracking a single composite value associated with an article that may be readily updated at the different transit points through which the article passes.

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of FIGS. 5, 6, and 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

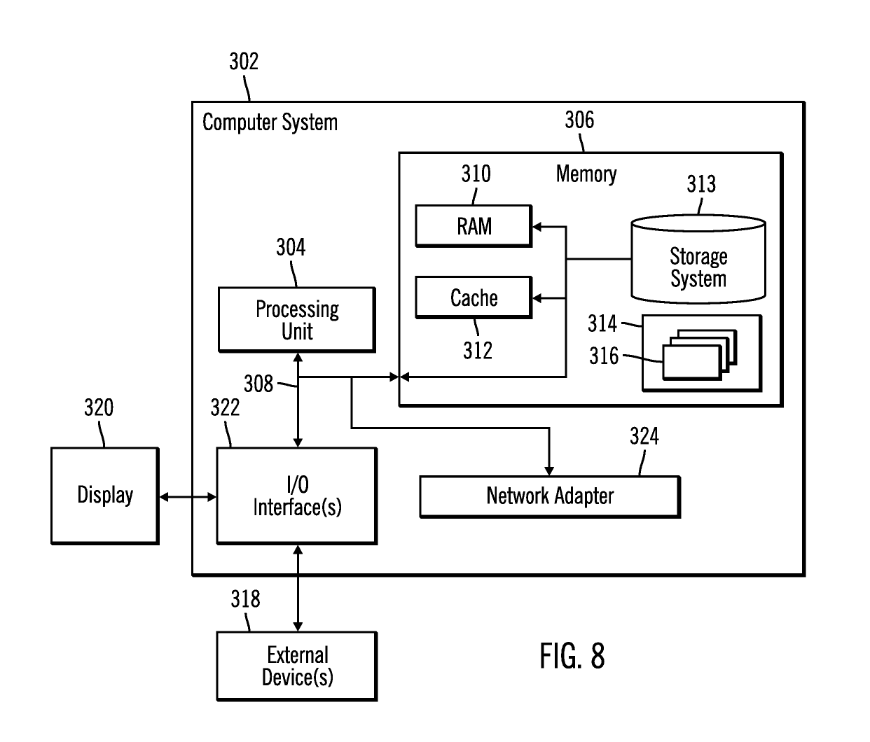

The computers 2, 14, and 100 may comprise a computer 302 shown in FIG. 8. Computer system/server 302 may be described in the general context of computer system executable instructions, such as program modules, being executed by a computer system. Generally, program modules may include routines, programs, objects, components, logic, data structures, and so on that perform particular tasks or implement particular abstract data types. Computer system/server 302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, the computer system/server 302 is shown in the form of a general-purpose computing device. The components of computer system/server 302 may include, but are not limited to, one or more processors or processing units 304, a system memory 306, and a bus 308 that couples various system components including system memory 306 to processor 304. Bus 308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 302 typically includes a variety of computer system readable media. Such media may be any available media that is accessible by computer system/server 302, and it includes both volatile and non-volatile media, removable and non-removable media.

System memory 306 can include computer system readable media in the form of volatile memory, such as random access memory (RAM) 310 and/or cache memory 312. Computer system/server 302 may further include other removable/non-removable, volatile/non-volatile computer system storage media. By way of example only, storage system 313 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 308 by one or more data media interfaces. As will be further depicted and described below, memory 306 may include at least one program product having a set (e.g., at least one) of program modules that are configured to carry out the functions of embodiments of the invention.

Program/utility 314, having a set (at least one) of program modules 316, may be stored in memory 306 by way of example, and not limitation, as well as an operating system, one or more application programs, other program modules, and program data. Each of the operating system, one or more application programs, other program modules, and program data or some combination thereof, may include an implementation of a networking environment. The tracker program 8, 110, transit point list 10a, 10b, 112, and article tracking information 12a, 12b may be implemented as program modules 316 which generally carry out the functions and/or methodologies of embodiments of the invention as described herein.

Computer system/server 302 may also communicate with one or more external devices 318 such as a keyboard, a pointing device, a display 320, etc.; one or more devices that enable a user to interact with computer system/server 12; and/or any devices (e.g., network card, modem, etc.) that enable computer system/server 302 to communicate with one or more other computing devices. Such communication can occur via Input/Output (I/O) interfaces 322. Still yet, computer system/server 302 can communicate with one or more networks such as a local area network (LAN), a general wide area network (WAN), and/or a public network (e.g., the Internet) via network adapter 324. As depicted, network adapter 324 communicates with the other components of computer system/server 302 via bus 308. It should be understood that although not shown, other hardware and/or software components could be used in conjunction with computer system/server 302. Examples, include, but are not limited to: microcode, device drivers, redundant processing units, external disk drive arrays, RAID systems, tape drives, and data archival storage systems, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for tracking an article passing through transit points, wherein the computer program product comprises a computer readable storage medium having computer readable program code embodied therein that executes to perform operations, the operations comprising:
maintaining a list associating prime numbers with transit points through which the article passes;
determining from the list, prime numbers associated with the transit points through which the article has passed;
performing a function on the determined prime numbers to determine a composite value;
generating an association of the composite value with the article; and
using the composite value associated with the article to determine at least one of the transit points through which the article has passed.

2. The computer program product of claim 1, wherein performing the function comprises multiplying the determined prime numbers of the transit points through which the article has passed to determine the composite value.

3. The computer program product of claim 1, wherein the using of the composite value comprises:
determining at least one prime number that is a factor of the composite value associated with the article;
determining at least one transit point associated with the determined at least one prime number; and
outputting the determined at least one transit point to indicate the at least one transit point through which the article has passed.

4. The computer program product of claim 1, wherein the using of the composite value comprises:
receiving user input indicating at least one selected transit point;
determining at least one prime number associated with the at least one selected transit point;
determining whether the at least one determined prime number is a factor of the composite value associated with the article;
determining the at least one transit point associated with the determined at least one prime number that is a factor of the composite value; and
outputting the determined at least one transit point to indicate the at least one transit point through which the article has passed.

5. The computer program product of claim 1, wherein the operations of determining the prime numbers and performing the function comprises performing at each transit point through which the article passes the following operations:
determining from the list a current prime number of a current transit point at which the article is located;
determining the composite value of the article;
performing the function on the determined composite value and the determined current prime number to generate a current composite value; and
updating the composite value of the article to the determined current composite value.

6. The computer program product of claim 5, wherein performing the function to generate the current composite value comprises multiplying the determined current prime number times the determined composite value.

7. The computer program product of claim 1, wherein generating the association of the composite value and the article comprises:
updating a file in a computer readable storage medium to indicate the composite value for the article.

8. The computer program product of claim 1, wherein generating the association of the composite value and the article comprises:
recording the composite value on the article or on a packaging of the article in which the article is contained while passing through the transit points.

9. A system for tracking an article passing through transit points, comprising:
a processor; and
a computer readable storage medium having code executed by the processor to perform operations, the operations comprising:
maintaining a list associating prime numbers with transit points through which the article passes;
determining from the list, prime numbers associated with the transit points through which the article has passed;
performing a function on the determined prime numbers to determine a composite value;
generating an association of the composite value with the article; and
using the composite value associated with the article to determine at least one of the transit points through which the article has passed.

10. The system of claim 9, wherein performing the function comprises multiplying the determined prime numbers of the transit points through which the article has passed to determine the composite value.

11. The system of claim 9, wherein the using of the composite value comprises:
determining at least one prime number that is a factor of the composite value associated with the article;
determining at least one transit point associated with the determined at least one prime number; and
outputting the determined at least one transit point to indicate the at least one transit point through which the article has passed.

12. The system of claim 9, wherein the using of the composite value comprises:
receiving user input indicating at least one selected transit point;
determining at least one prime number associated with the at least one selected transit point;
determining whether the at least one determined prime number is a factor of the composite value associated with the article;
determining the at least one transit point associated with the determined at least one prime number that is a factor of the composite value; and
outputting the determined at least one transit point to indicate the at least one transit point through which the article has passed.

13. The system of claim 9, wherein the operations of determining the prime numbers and performing the function comprises performing at each transit point through which the article passes the following operations:
determining from the list a current prime number of a current transit point at which the article is located;
determining the composite value of the article;
performing the function on the determined composite value and the determined current prime number to generate a current composite value; and
updating the composite value of the article to the determined current composite value.

14. The system of claim 9, wherein generating the association of the composite value and the article comprises:
recording the composite value on the article or on a packaging of the article in which the article is contained while passing through the transit points.

15. A method for tracking an article passing through transit points, comprising:
maintaining a list associating prime numbers with transit points through which the article passes in a computer readable storage medium;
determining from the list, prime numbers associated with the transit points through which the article has passed;
performing a function on the determined prime numbers to determine a composite value;
generating an association of the composite value with the article; and
using the composite value associated with the article to determine at least one of the transit points through which the article has passed.

16. The method of claim 15, wherein performing the function comprises multiplying the determined prime numbers of the transit points through which the article has passed to determine the composite value.

17. The method of claim 15, wherein the using of the composite value comprises:
determining at least one prime number that is a factor of the composite value associated with the article;
determining at least one transit point associated with the determined at least one prime number; and
outputting the determined at least one transit point to indicate the at least one transit point through which the article has passed.

18. The method of claim 15, wherein the using of the composite value comprises:
receiving user input indicating at least one selected transit point;
determining at least one prime number associated with the at least one selected transit point;
determining whether the at least one determined prime number is a factor of the composite value associated with the article;
determining the at least one transit point associated with the determined at least one prime number that is a factor of the composite value; and
outputting the determined at least one transit point to indicate the at least one transit point through which the article has passed.

19. The method of claim 15, wherein the operations of determining the prime numbers and performing the function comprises performing at each transit point through which the article passes the following operations:
determining from the list a current prime number of a current transit point at which the article is located;
determining the composite value of the article;
performing the function on the determined composite value and the determined current prime number to generate a current composite value; and
updating the composite value of the article to the determined current composite value.

20. The method of claim 15, wherein generating the association of the composite value and the article comprises:
recording the composite value on the article or on a packaging of the article in which the article is contained while passing through the transit points.
